(19) United States
(12) Patent Application Publication
(10) Pub. No.: US 2011/0122658 A1
(43) Pub. Date: May 26, 2011

(54) POWER CONVERTER USING ENERGY STORED IN LEAKAGE INDUCTANCE OF TRANSFORMER TO POWER SWITCH CONTROLLER

(75) Inventors: Eng Hwee Quek, Singapore (SG); Jun Zheng, Guangdong (CN)

(73) Assignee: IWATT INC., Los Gatos, CA (US)

(21) Appl. No.: 13/055,928

(22) PCT Filed: Aug. 6, 2008
(86) PCT No.: PCT/CN2008/001429

§ 371 Date: Jan. 25, 2011

(51) Int. Cl. H02M 3/335; H02M 7/217

(52) U.S. Cl. 363/21.12; 363/131

(57) ABSTRACT

The power converter includes a transformer that is coupled or decoupled from a power source by a switch controlled by a switch controller. The transformer includes a first primary winding coupled to a secondary winding. The energy stored in the leakage inductance of the first primary winding is received by a second primary winding. The energy received by the second primary winding is provided to the switch controller to power the switch controller. The second primary winding is wound adjacent to the first primary winding to receive more energy from the first primary winding.

### BACKGROUND OF THE INVENTION

1. Field of the Invention

The present invention relates generally to a power converter, and more specifically, to a power converter using energy stored in the leakage inductance of a transformer to power a switch controller of the power converter.

2. Description of the Related Art

The leakage inductance of the transformer in a power converter is often a large factor in degrading the performance of the power converter. The leakage inductance of the transformer slows down switching transitions and steals a significant amount of energy that is to be delivered to an output of the power converter. Therefore, it is generally preferable to decrease the leakage inductance in the power converter. The leakage inductance, however, cannot be eliminated due to non-ideal properties of the transformer.

The leakage inductance can also cause damage to a switch (typically a bipolar junction transistor or a field effect transistor) in the power converter because the energy stored in the leakage inductance causes spikes in the voltage across the primary winding of the transformer. The voltage spike causes excessive current through the switch that may damage the switch. Therefore, a clamp is generally coupled between the primary winding of the transformer and ground to prevent the voltage spike across the primary winding from damaging the switch. The clamp protects the switch by diverting the excessive current away from the switch. The energy in the form of diverted current, however, is wasted and not put to any use by the power converter. The waste of the diverted current reduces the overall efficiency of the power converter.

The energy stored in the leakage inductance increases as the load coupled to the power converter increases. The energy stored in the leakage inductance of the primary winding of the transformer is represented as

$$E = \frac{1}{2} {L}_{k} {I}_{p}^{2}$$

where Lₖ is the leakage inductance and Iₚ is the current in the primary winding of the transformer. An increased load of the power converter is accompanied by increased current Iₚ in the primary winding. The increased current in the primary winding Iₚ in turn results in increase of energy E stored in the leakage inductance Lₖ. Therefore, more energy is lost from the leakage inductance Lₖ when the load of the power converter is increased.

Another issue with the leakage inductance is the electromagnetic interference (EMI). The transformer has parasitic capacitance between the windings. The parasitic capacitance in conjunction with the leakage inductance Lₖ of the transformer causes EMI emission from the power converter. In order to reduce EMI, an RC snubber is generally placed across the primary winding of the transformer. The RC snubber, however, decreases the efficiency of the power converter because the RC snubber slows down switching transition. Specifically, when a switch in the power converter is turned off, energy stored in the RC snubber manifests itself as added voltage across the primary winding. Also, when the switch is turned on, the RC snubber increases the initial current spike. The increase in the voltage and the current spike increases switching loss in the power converter. Further, the current spike caused by the RC snubber may also distort the current waveform across the primary winding, causing faulty detection of the current across the primary winding. Therefore, it is necessary to implement measures to reduce EMI generated by the power converter without using the RC snubber across the primary winding of the transformer.

Therefore, there is a need for a power converter that can utilize the energy stored in the leakage inductance to increase efficiency. There is also a need for a power converter that obviates a clamp for diverting an excessive current away from the primary winding. Moreover, there is a need for a power converter that reduces EMI emission without decreasing the efficiency of the power converter.

### SUMMARY OF INVENTION

One embodiment of the present invention includes a power converter including a transformer that uses the energy stored in the leakage inductance of the first primary winding of the transformer to provide at least part of the power needed for operating a switch controller. The switch controller controls on-times and off-times of a switch that couples or decouples the transformer to or from a power source of the power converter through a transformer to regulate an output voltage of the power converter to the load.

In one embodiment of the present invention, the transformer includes a secondary primary winding that receives at least part of the energy stored in the leakage inductance of the first primary winding. The secondary primary winding is coupled to the switch controller to provide the energy received from the first primary winding to the switch controller.

In another embodiment of the present invention, the first primary winding and the second primary winding are wound around the core of the transformer in an alternating manner.

In one embodiment, the power converter includes a third primary winding coupled to sense an output voltage of the power converter to the load from the secondary winding. The second primary winding may have a greater number of turns than the third primary winding. The third primary winding is wound adjacent to the secondary winding.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the present invention can be readily understood by considering the following detailed description in conjunction with the accompanying drawings.

FIG. 1 is a schematic illustrating a power converter according to one embodiment of the present invention.

FIG. 2 is a schematic illustrating primary windings and a secondary winding of a transformer according to one embodiment of the present invention.

FIG. 3 is a cross-sectional view of a transformer according to one embodiment of the present invention.

FIG. 4 is a cross-sectional view of a transformer according to another embodiment of the present invention.

FIG. 5 is a flowchart illustrating a method of delivering power from a power source to a load according to one embodiment of the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

In one embodiment, the energy stored in the leakage inductance of a transformer of a power converter is utilized to provide at least part of the power needed to operate a switch controller of the power converter. By using the energy stored in the leakage inductance (otherwise dissipated or wasted), the overall efficiency of the power converter is increased because less power is drawn from the input of the power converter to power the switch controller. Moreover, by using the energy stored in the leakage inductance, the electromagnetic interference (EMI) emission of the power converter may also be reduced.

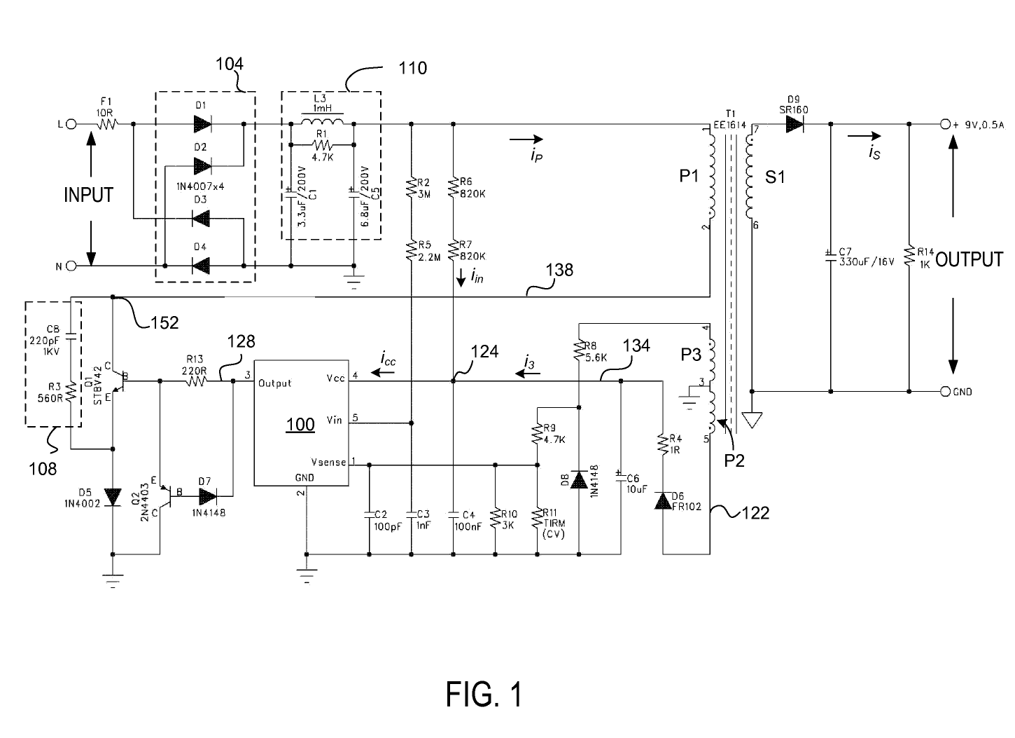

FIG. 1 illustrates a flyback-type AC-DC power converter with primary-side sensing according to one embodiment of the present invention. Although the power converter of FIG. 1 is a flyback converter with primary side sensing of the feedback signals, it should be noted that the present invention is not limited to a flyback converter and that it can be applied to any type of power converter of any topology. The power converter includes, among other components, a transformer T1, a switch Q1, an output rectifier diode D9, an output filter capacitor C7, a switch controller 100, resistors R6 and R7, a diode D6, a diode D9, a bridge rectifier 104, and a RC snubber 108. Other components, an EMI filtering circuit 110, resistors R2 and R5, diodes D5 and D7, a bipolar junction transistor (BJT) Q2, a resistor R13, and capacitors C2-C4, not directed related to the present invention are not explained herein. The EMI filtering circuit 110 reduces differential mode noise in the rectified voltage input from the rectifier 104.

The transformer T1 includes, among other components, a first primary winding P1, a second primary winding P2, a third primary winding P3, and a secondary winding S1. The primary side (coupled to the power source) of the transformer T1 includes the first primary winding P1, the second primary winding P2 and the third primary winding P3. The secondary side (coupled to the load) of the transformer T1 includes the secondary winding S1.

Referring to FIG. 1, the bridge rectifier 104 receives an input AC voltage from the power source INPUT and converts it into a full-wave rectified voltage. The rectified voltage is applied to the transformer T1 via the EMI filtering circuit 110. When the switch Q1 is turned on, a current iₚ flows through the first primary winding P1 of the transformer T1, storing the energy in the mutual inductance L_{M} of the first primary winding P1. The current iₚ then flows to ground via a line 138, the switch Q1, and a diode D5. A switch Q2 in conjunction with the switch Q1 forms a part of a switching circuit. A diode D7 functions to protect the switch Q2 from a current flowing from the switch Q1 when the switch Q1 is turned off.

When the switch Q1 is turned off, the energy stored in the leakage inductance Lₖ and the mutual inductance L_{M} of the first primary winding P1 is released. The energy released from the mutual inductance L_{M} of the first primary winding P1 is received by the secondary winding S1 because the diode D9 becomes forward biased when the switch Q1 is turned-off. The secondary side diode D9 rectifies a current iₛ to provide an output (OUTPUT) voltage at the output of the power converter.

Likewise, the energy released from the leakage inductance Lₖ of the first primary winding P1 is coupled to and received by the second primary winding P2 when the switch Q1 is turned off because the diode D6 is forward biased. The energy received by the second primary winding P2 is provided as a current i₃ to a node 124 via a path 134 that includes the capacitor C6 and a resistor R4. To lower the impedance of the path 134, the capacitor C6 with a large capacitance is used. The current i₃ from the second primary winding P2 merges with a current iᵢₙ from the EMI filtering circuit 110 via resistors R6, R7 at node 124 to form a supply current i_{cc}. A capacitor C4 is placed between the node 124 and ground to help increase common mode rejection ratio (CMRR) of supply voltage (Vcc) at pin 4 of the switch controller 100. The supply current i_{cc} is provided to node 4 of the switch controller 100 to power the switch controller 100. Note that part of the energy stored in the leakage inductance Lₖ of the first primary winding P1 is converted to the current i₃ to provide part of the power necessary to operate the switch controller 100. Therefore, the switch controller 100 can draw less current iᵢₙ (i.e., energy) from the input (INPUT) of the power converter. By drawing less current iᵢₙ from the input (INPUT) of the power converter to power the switch controller 100, the overall efficiency of the power converter is increased.

In one embodiment, the switch controller 100 receives at node 1 a divided-down version (Vₛₑₙₛₑ) of voltage across the third primary winding P3 via a network of resistors (R₈, R₉, R₁₀ and R₁₁) and a capacitor C2. A diode D8 is coupled across the third primary winding P3. The switch controller 100 also receives at node 5 an input voltage (Vᵢₙ) which is a scaled down version of the output voltage of the bridge rectifier 104 as passed through the EMI filtering circuit 110. Based on Vₛₑₙₛₑ and Vᵢₙ, the switch controller 100 determines the on-times and off-times of an output signal 128 from its output node (node 3). The output signal 128 to the switch Q1 via the resistor R13 turns on and turns off the switch Q1.

In another embodiment, the third primary winding P3 is omitted and its function is replaced with the second primary winding P2. In this embodiment, a voltage across the second primary winding P2 is divided down to obtain Vₛₑₙₛₑ. Vₛₑₙₛₑ is fed into the switch controller 100 to determine the on-times and off-times of the output signal 128.

In one embodiment, an RC snubber 108 is placed in parallel with the switch Q1 to protect the switch Q1 from the voltage spike at node 152 caused by energy in the leakage inductance Lₖ that is not received by the second primary winding P2. Although it would be ideal to have the secondary primary winding P2 receive all the energy in the leakage inductance Lₖ, some energy (“leftover energy”) in the leakage inductance Lₖ is not received by the second primary winding P2 due to, among other reasons, imperfect coupling of the first primary winding P1 and the second primary winding P2. Such leftover energy causes voltage spike at node 152. The voltage spike across the switch Q1, however, is smaller when the second primary winding P2 is used because the second primary winding P2 receives at least part of the energy stored in the leakage inductance Lₖ. Because the voltage spike at node 152 is decreased, a smaller RC snubber with smaller RC time constant can be placed across the switch Q1 compared to a power converter that does not use the second primary winding P3. The smaller RC snubber leads to less switching loss. Therefore, by using the second primary winding P2 to receive the energy stored in the leakage inductance Lₖ of the first primary winding P1 and by using that energy to power the switch controller 100, the overall efficiency of the power converter is increased and EMI emission of the power converter is reduced. In one or more embodiments, the RC snubber 108 may be omitted if the energy spike at node 152 is low enough so that the switch Q1 is not damaged.

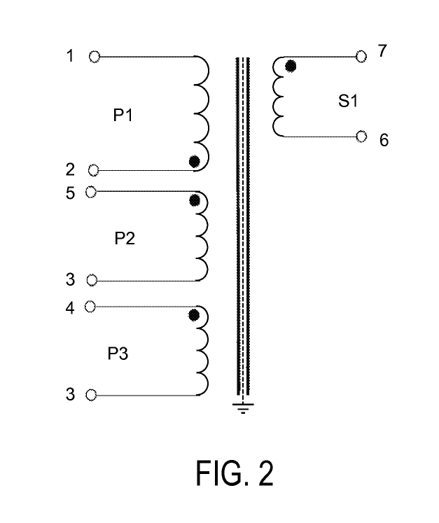

FIG. 2 is a schematic illustrating the primary windings P1-P3 and the secondary winding S1 of a transformer T1 according to one embodiment of the present invention. The first primary winding P1 is wound in a first direction around the core of the transformer T1 starting from pin 1 of the transformer T1 and ending at pin 2 of the transformer T1. The second primary winding P2 is wound in a second direction opposite to the first direction, starting from pin 5 of the transformer T1 and ending at pin 3 of the transformer T1. The third primary winding P3 is wound in the second direction, starting from pin 4 of the transformer T1 and ending at pin 3 of the transformer T1. The secondary winding S1 of the transformer T1 is wound in the second direction, starting from pin 7 of the transformer T1 and ending at pin 6 of the transformer T1. Note that the end of the second primary winding P2 shares pin 3 with the end of the third primary winding P3 in the example shown in FIG. 2, although the first primary winding P1 and the second primary winding P2 may be coupled to separate different pins and not share a pin of the transformer T1.

Referring back to FIG. 1, pin 1 of the transformer T1 is coupled to the rectifier bridge 104 via the EMI filtering circuit 110. Pin 2 of the transformer T1 is coupled to the node 152. Pin 3 of the transformer T1 is grounded. Pin 5 is coupled to the diode D6. Pin 6 of the transistor T1 is also grounded. Pin 7 of the transistor T1 is coupled to the diode D9.

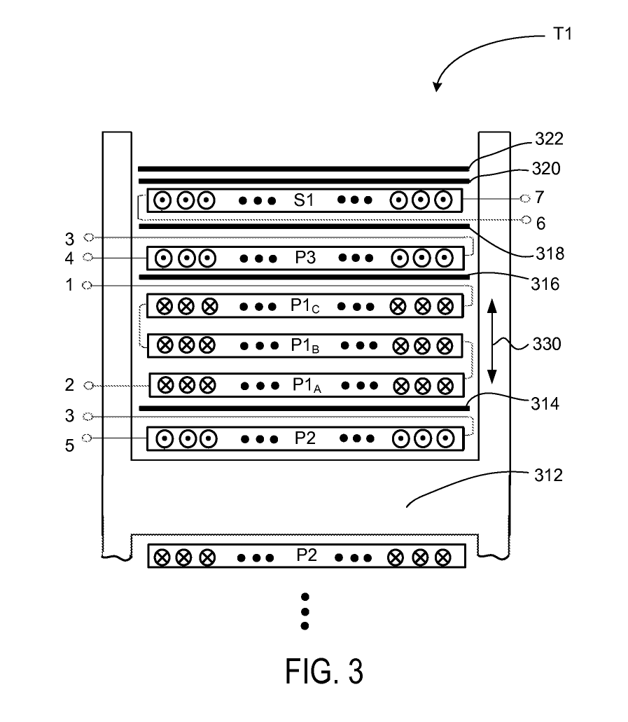

FIG. 3 is a cross-sectional view of the transformer T1 according to one embodiment of the present invention. The second primary winding P2 is wound around the core 312 of the transformer T1 adjacent to the core 312. Then the first primary winding P1 (including a first layer P1_{A}, a second layer P1_{B}, and a third layer P1_{C}) is wound around the second primary winding P2. By winding the second primary winding P2 adjacent to the first primary winding P1, the second primary winding P2 can receive most effectively the energy from the leakage inductance Lₖ of the first primary winding P1 when the switch Q1 is turned off. As the second primary winding P2 receives most effectively energy from the first primary winding P1, the second primary winding P2 can provide more energy to the switch controller 100 via the node 124 (shown in FIG. 1).

Then the third primary winding P3 is wound around the first primary winding P1, and the secondary winding S1 is wound around the third primary winding P3. Winding the secondary winding S1 adjacent to the third primary winding P3 is advantageous because the third primary winding P3 can receive the energy from the secondary winding S1 most effectively. Further, placing the third primary winding P3 between the first primary winding P1 and the secondary winding S1 reduces common mode EMI noise.

A first insulation layer 314 is placed between the second primary winding P2 and the first primary winding P1 to provide insulation between the second primary winding P2 and the first primary winding P1. A second insulation layer 316 is placed between the first primary winding P1 and the third primary winding P3 to provide insulation between the first primary winding P1 and the third primary winding P3. A third insulation layer 318 is placed between the third primary winding P3 and the secondary winding S1 to provide insulation between the third primary winding P3 and the secondary winding S1. The secondary winding S1 is then covered with a fourth insulation layer 320 and a fifth insulation layer 322. The directions of the turns in the primary windings P1, P2, P3 and the secondary winding S1 are as explained above with reference to FIG. 2.

In one embodiment, the first primary winding P1 has the most number of turns among all of the windings of the transformer T1. The second primary winding P2 has more number of turns than the third primary winding P3. For example, the first primary winding P1 has fifty-three (53) turns, the second primary winding P2 has sixteen (16) turns, the third primary winding P3 has thirteen (13) turns, and the secondary winding S1 has seventeen (17) turns. It is advantageous for the second primary winding P2 to have more turns than the third primary winding P3 because more energy stored in the leakage inductance Lₖ may be received from the first primary winding P1.

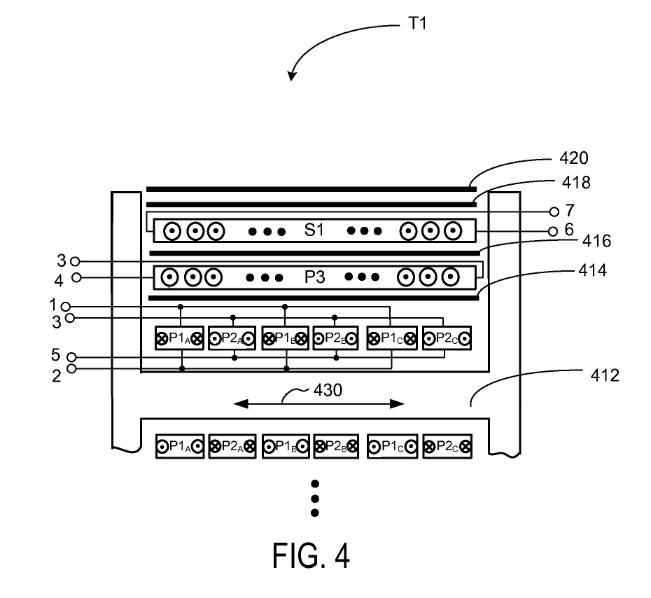

FIG. 4 is a cross-sectional view of the transformer T1 according to another embodiment of the present invention. In this embodiment, the first primary winding P1 and the second primary winding P2 are wound around the core 412 of the transformer T1 in an alternating manner along the longitudinal direction 430 of the core 412. Specifically, a first portion P1_{A} of the first primary winding is wound around the core 412, followed by a first portion P2_{A} of the second primary winding, and then the second portion P1_{B} of the first primary winding followed by the second portion P2_{B} of the second primary winding and so forth. The first primary winding P1_{A} to P1_{C} and the second primary winding P2_{A} to P2_{C} are covered with a first insulation layer 414 to insulate the first primary winding P1 and the second primary winding P2. Then a third primary winding P3 is wound around the first insulation layer 414. Then a second insulation layer 416 is placed around the third primary winding P3. A secondary winding S1 is wound around the second insulation layer 416. A third insulation layer 418 and a fourth insulation layer 420 are placed around the secondary winding 51.

The connection of transistor pins to the windings in the embodiment of FIG. 4 is identical to the embodiment of FIG. 3. Specifically, one end of the first primary winding P1 is coupled to pin 1, and the other end of the first primary winding P1 is coupled to pin 2. One end of the second primary winding P2 is coupled to pin 3 and the other end of the second primary winding P2 is coupled to pin 5. One end of the third primary winding P3 is coupled to pin 3, and the other end of the third primary winding P3 is coupled to pin 4. Finally, one end of the secondary winding 51 is coupled to pin 6 and the other end of the secondary winding 51 is coupled to pin 7. The directions of the turns in the windings P1, P2, P3 and 51 of the embodiment of FIG. 4 are identical to the directions of the turns in the windings P1, P2, P3 and 51 of the embodiment of FIG. 3, respectively, as explained above with reference to FIGS. 2 and 3.

The functions of the windings P1, P2, P3 and S1 of the embodiment of FIG. 4 are substantially the same as the windings P1, P2, P3 and S1 of the embodiment of FIG. 3, respectively.

As in the embodiment of FIG. 3, the first primary winding P1 (P1_{A} to P1_{C}) has the most number of turns among all of the windings in the transformer of FIG. 4. Note that the second primary winding P2 (P2_{A} to P2_{C}) is adjacent to the first primary winding P1 (P1_{A} to P1_{C}) as in the embodiment of FIG. 3 although in a different direction. That is, in the embodiment of FIG. 3, the first primary winding P1 and the second primary winding P2 are adjacent in the radial direction 330 of the core 312 whereas in the embodiment of FIG. 4, the first primary winding P1 (P1_{A} to P1_{C}) and the second primary winding P2 (P2_{A} to P2_{C}) are adjacent in the longitudinal direction 430 of the core 412. Also note that the secondary winding S1 is adjacent to the third primary winding P3 as in the embodiment of FIG. 3.

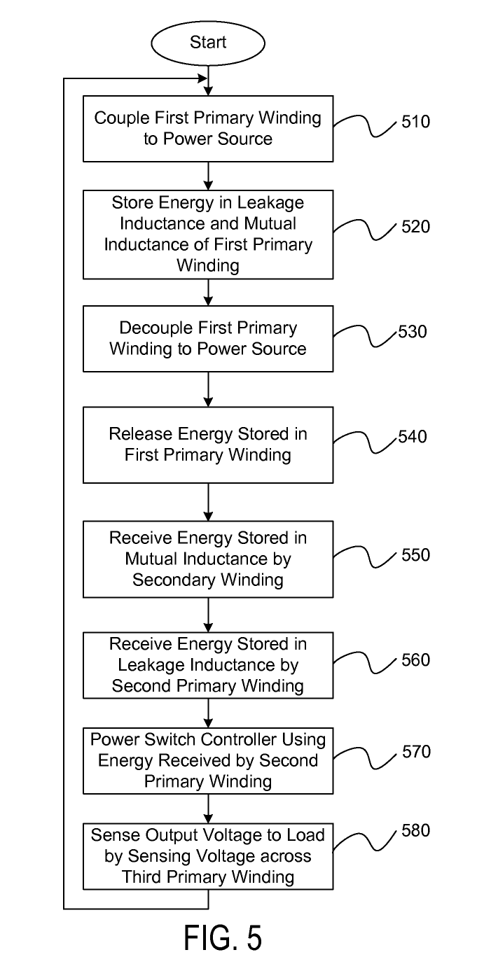

FIG. 5 is a flowchart illustrating a method of delivering power from a power source to a load according to an embodiment of the present invention. First, the switch Q1 is turned on to couple 510 the first primary winding P1 of the transformer T1 to the power source of the power converter. When the switch Q1 is turned on, the energy from the power source is stored 520 in the leakage inductance Lₖ and the mutual inductance L_{M} (coupled with the secondary winding S1) of the first primary winding P1.

When the switch Q1 is turned off, the first primary winding P1 is decoupled 530 from the power source of the power converter. As a result, the energy stored in the leakage inductance Lₖ and the mutual inductance L_{M} of the first primary winding P1 is released 540 from the first primary winding P1. The energy stored in the mutual inductance L_{M} of the first primary winding P1 is received 550 by the secondary winding S1. The energy stored in the leakage inductance Lₖ of the first primary winding P1 is received 560 by the second primary winding P2. The energy received by the second primary winding P2 is then used 570 to power the switch controller 100. By using the energy received from the leakage inductance Lₖ of the first primary winding P1, the overall efficiency of the power converter is increased. Then the output voltage of the power converter is sensed 580 by the third primary winding P3 to control the on-times and off-times of the switch Q1. The process then returns to step 510.

Although the present invention has been described above with respect to several embodiments, various modifications can be made within the scope of the present invention. Accordingly, the disclosure of the present invention is intended to be illustrative, but not limiting, of the scope of the invention, which is set forth in the following claims.

What is claimed is:

1. A power converter comprising:
a transformer coupled between a power source and a load;
a switch coupled to the transformer for coupling or decoupling the load to or from the power source through the transformer; and
a switch controller coupled to the switch for controlling on-times and off-times of the switch, the switch controller powered at least in part by energy stored in leakage inductance of a first primary winding of the transformer.

2. The power converter of claim 1, wherein the transformer comprises:
a secondary winding coupled to the load; and
a second primary winding receiving at least part of the energy stored in the leakage inductance of the first primary winding, the second primary winding coupled to the switch controller to power the switch controller.

3. The power converter of claim 2, wherein the second primary winding is wound adjacent to the first primary winding around a core of the transformer.

4. The power converter of claim 3, wherein the first primary winding and the second primary winding are separated by an insulation layer.

5. The power converter of claim 2, wherein the transformer further comprises:
a third primary winding coupled to sense an output voltage of the power converter to the load from the secondary winding.

6. The power converter of claim 5, wherein the second primary winding has a greater number of turns than the third primary winding.

7. The power converter of claim 5, wherein the third primary winding is wound adjacent to the secondary winding.

8. The power converter of claim 5, wherein:
the second primary winding is wound around a core of the transformer;
the first primary winding is wound around the second primary winding separated by a first insulation layer;
the third primary winding is wound around the first primary winding separated by a second insulation layer; and
the secondary winding is wound around the third primary winding separated by a third insulation layer.

9. The power converter of claim 5, wherein:
the first primary winding and the second primary winding are wound around a core of the transformer in an alternating manner;
the third primary winding is wound around the first primary winding and the second primary winding separated by a first insulation layer; and
the secondary winding is wound around the third primary winding separated by a second insulation layer.

10. The power converter of claim 2, wherein the second primary winding senses an output voltage of the power converter to the load from the secondary winding.

11. The power converter of claim 1, wherein the power converter is a primary side sensing flyback AC-DC power converter.

12. A transformer used in a power converter and coupled between a power source, a load, and a switch controller controlling a switch coupled to the transformer for coupling or decoupling the load to or from the power source through the transformer, the transformer comprising:
a first primary winding coupled to the power source;
a second primary winding coupled to receive at least part of energy stored in a leakage inductance of the first primary winding to power the switch controller; and
a secondary winding coupled to the load.

13. The transformer of claim 12, wherein the second primary winding is wound adjacent to the first primary winding around a core of the transformer.

14. The transformer of claim 12, wherein the first primary winding and the second primary winding are separated by an insulation layer.

15. The transformer of claim 12, further comprising a third primary winding coupled to sense an output voltage of the power converter to the load from the secondary winding.

16. The transformer of claim 15, wherein the second primary winding has a greater number of turns than the third primary winding.

17. The transformer of claim 15, wherein the third primary winding is wound adjacent to the secondary winding.

18. The transformer of claim 15, wherein:
the second primary winding is wound around a core of the transformer;
the first primary winding is wound around the second primary winding separated by a first insulation layer;
the third primary winding is wound around the first primary winding separated by a second insulation layer; and
the secondary winding is wound around the third primary winding separated by a third insulation layer.

19. The transformer of claim 16, further comprising:
the first primary winding and the second primary winding are wound around a core of the transformer in an alternating manner;
the third primary winding is wound around the first primary winding and the second primary winding separated by a first insulation layer; and
the secondary winding is wound around the third primary winding separated by a second insulation layer.

20. The transformer of claim 12, wherein the second primary winding senses an output voltage of the power converter to the load from the secondary winding.

21. A method of delivering power from a power source to a load, the method comprising:
switching on and off a switch that couples or decouples the load to or from the power source through a transformer; and
powering a switch controller for controlling the switch based at least in part on energy stored in leakage inductance of a first primary winding of a transformer having a primary side and a secondary side.

22. The method of claim 21, powering the switch controller comprises:
storing energy in the leakage inductance of the first primary winding; and
at a second primary winding of the transformer, receiving at least part of the energy stored in the leakage inductance of the first primary winding; and
powering the switch controller using the energy received at the second primary winding.

23. The method of claim 22, further comprising sensing an output voltage to the load from a secondary side at the second primary winding.
